(19) United States
(12) Patent Application Publication
(10) Pub. No.: US 2011/0144831 A1
(43) Pub. Date: Jun. 16, 2011

(54) POWER SUPPLY CONTROL SYSTEM AND POWER SUPPLY CONTROL METHOD

(75) Inventor: Akiyoshi Hata, Tokyo (JP)

(73) Assignee: Mitsubishi Electric Corporation, Tokyo (JP)

(21) Appl. No.: 13/058,012

(22) PCT Filed: Feb. 24, 2009
(86) PCT No.: PCT/JP2009/053259

§ 371 Date: Feb. 8, 2011

(30) Foreign Application Priority Data
Sep. 3, 2008 (JP) 2008-226021

(51) Int. Cl. G05F 1/66; B61C 3/00

(52) U.S. Cl. 701/2

(57) ABSTRACT

In a power supply control system that controls supplied power to a train using a remote control apparatus provided on a substation side and a train-information managing apparatus provided in a train, the train-information managing apparatus transmits present train location information indicating a location where the train is traveling and information concerning consumed/regenerated electric power amount to the remote control apparatus. The remote control apparatus extracts, out of the input consumed/regenerated electric power amount information, based on the present train location information, consumed/regenerated electric power amount information concerning a train traveling in a power section, calculates a total value of the consumed/regenerated electric power amount information, and controls, based on the calculated total value of the consumed/regenerated electric power amount information, electric power amount supplied to the power section.

### TECHNICAL FIELD

The present invention relates to a power supply control system and a power supply control method for performing power supply control in electric railroads.

### BACKGROUND ART

In recent years, in trains in service, in particular, local trains and express trains, a regeneration brake that causes an electric motor to act as a generator during braking and supplies electric power from a car to a wire is adopted. In a main circuit that performs control of electric power between the wire and the car, a VVVF (Variable Voltage Variable Frequency) inverter circuit that performs control of acceleration traveling and constant speed traveling (hereinafter, “power running”) and braking by changing the voltage and the frequency of the electric motor is adopted and electric power is finely controlled. An energy transmission and reception control system disclosed in Patent Document 1 described below enables power exchange among a plurality of railroad cars traveling in the same railroad section.
Patent Document 1: Japanese Patent Application Laid-open No. 2004-304989

### DISCLOSURE OF INVENTION

### Problem to be Solved by the Invention

The energy transmission and reception control system disclosed in Patent Document 1 performs power exchange among railroad cars traveling in the same railroad section by performing required communication between the power amount transmission and reception control system and respective other railroad cars (trains) traveling in the same railroad section or between the power amount transmission and reception control system and a radio communication control apparatus that performs radio communication between the radio communication control apparatus and a ground control apparatus that manages the railroad cars traveling in the same railroad section. Therefore, when other railroad cars that consume electric power are present in the same railroad section, it is possible to perform power exchange between the power amount transmission and reception control system and the railroad cars.

However, when other railroad cars that consume electric power are not present in the same railroad section or when, even if a large number of railroad cars that perform power regeneration are present in the same railroad section, there are a small number of railroad cars that consume electric power, most of regenerated power cannot be returned to a wire. There is no other effective method but to use load resistance or the like, and to consume the regenerated power by converting into the thermal energy. When the regenerated power cannot be returned to the wire, in some case, regeneration is deactivated on a main circuit side. In other words, in the related art, there is a problem in that regenerated power generated in a train cannot be effectively used.

The present invention has been made in view of the above and it is an object of the present invention to provide a power supply control system and a power supply control method that can effectively use regenerated power generated in a train without uselessly consuming the regenerated power.

### Means for Solving Problem

In order to solve above-mentioned problems and to achieve the object, a power supply control system according to the present invention controls supplied power to a train using a remote control apparatus provided on a substation side and a train-information managing apparatus provided in the train, which collectively manages train information and transmits collected train information to the remote control apparatus via a wide area network, wherein the train-information managing apparatus outputs present train location information indicating a location where the train is traveling and consumed/regenerated electric power amount information indicating consumed electric power amount and regenerated electric power amount of the train, which are calculated from a wire voltage value and a main circuit current value observed in a main circuit of a power converting apparatus provided in the train, to the remote control apparatus, and the remote control apparatus extracts, out of the input consumed/regenerated electric power amount information, based on the present train location information attached to the consumed/regenerated electric power amount information, consumed/regenerated electric power amount information concerning a train traveling in a power section as a control target, calculates a total value of the extracted consumed/regenerated electric power amount information, and controls, based on the calculated total value of the consumed/regenerated electric power amount information, electric power amount supplied to the power section as the control target.

### Effect of the Invention

With the power supply control system according to the present invention, the remote control apparatus provided on the substation side extracts, out of input consumed/regenerated electric power amount information, based on present train location information attached to the consumed/regenerated electric power amount information, consumed/regenerated electric power amount information concerning a train traveling in a power section as a control target, calculates a total value of the extracted consumed/regenerated electric power amount information, and controls, based on the calculated total value of the consumed/regenerated electric power amount information, electric power amount supplied to the power section as the control target. Therefore, the power supply control system has an advantage that it is possible to effectively use regenerated power generated in the train without uselessly consuming the regenerated power.

### BRIEF DESCRIPTION OF DRAWINGS

FIG. 1 is a schematic diagram of a power supply control system according to a first embodiment.

FIG. 2 is a diagram of a configuration example mainly on a train side of the power supply control system according to the first embodiment.

FIG. 3 is a diagram of a configuration example mainly on a substation side and an example of connection of the power supply control system to a wide area network according to the first embodiment.

FIG. 4 is a diagram of a configuration example mainly on a train side of a power supply control system according to a second embodiment.

### EXPLANATIONS OF LETTERS OR NUMERALS

1 Train
11 Front car
110 Power converting apparatus
111 Motor
112 Pantograph
113 Main circuit
114, 114a Train-information managing apparatuses
115, 115a Monitor apparatuses of front cars
116 Train-information transmitting and receiving apparatus
117 Train antenna
118 Capacitor
12 Driven car
125 Monitor apparatus of driven car
2, 2A, 2B Substations
21 Power transformation facility
211 Disconnector
212 Breaker
213 Systems
213a Breakers
213b Transformers
213c Rectifiers
213d Disconnectors
214 DC breakers
22 Switchboard
23 Remote control apparatus
3 Wide area network
4 Direction center
5 Wire
6 Bus
8 Communication path

### BEST MODE(S) FOR CARRYING OUT THE INVENTION

Embodiments of a power supply control system and a power supply method according to the present invention are explained in detail below based on the drawings. The present invention is not limited by the embodiments.

### First Embodiment

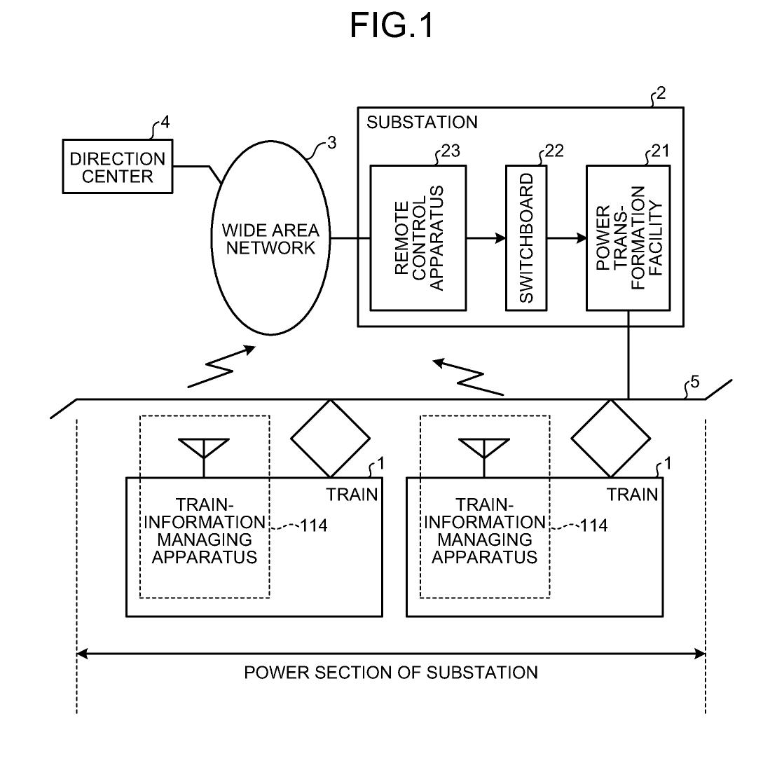

FIG. 1 is a schematic diagram of a power supply control system according to a first embodiment of the present invention. A substation 2 includes a remote control apparatus 23 that performs control of a power transformation facility 21 via a switchboard 22. A train 1 includes a train-information managing apparatus 114 that performs control of equipment mounted on the train 1 and management of information and transmits collected information to the remote control apparatus 23 of the substation 2 via, for example, a wide area network 3.

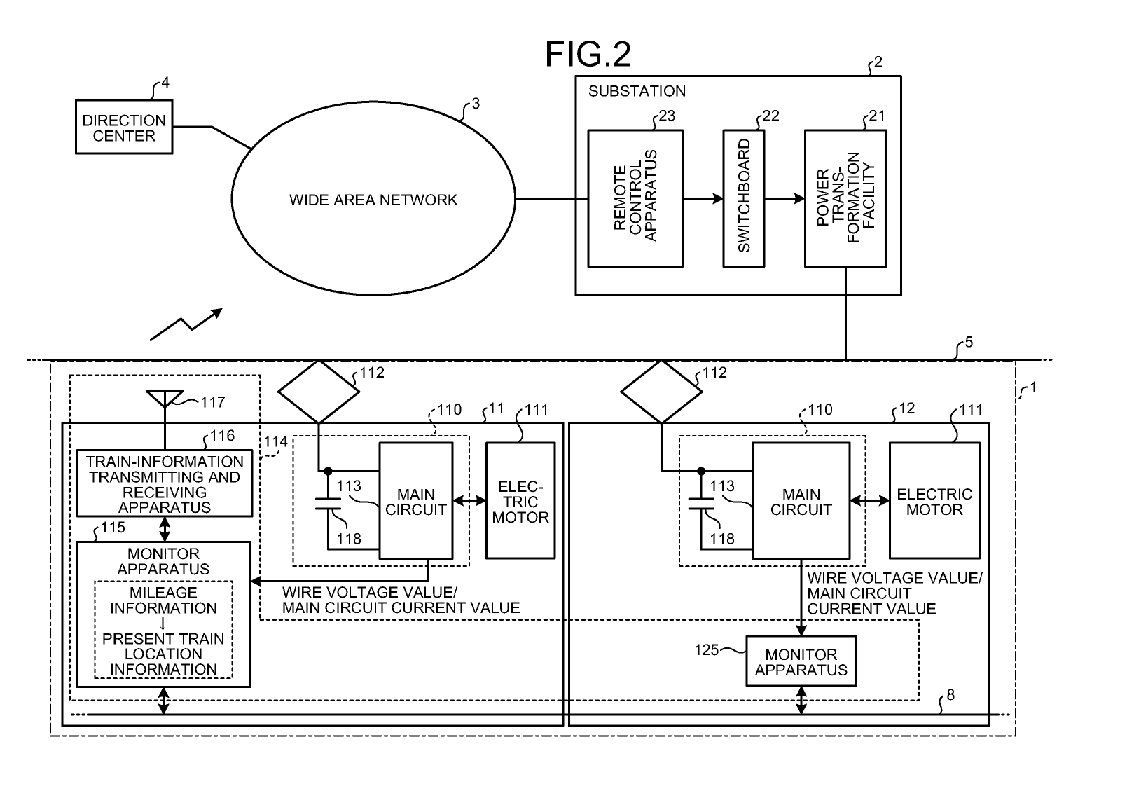

The configuration and the operation on a train side of the power supply control system according to the first embodiment are explained. FIG. 2 is a diagram of a configuration example mainly on a train side of the power supply control system according to the first embodiment.

In FIG. 2, the train 1 is made up of a front car 11 and a driven car 12 other than the front car. The front car 11 includes an electric motor 111, a pantograph 112, a power converting apparatus 110, and a monitor apparatus 115, a train-information transmitting and receiving apparatus 116, and a train antenna 117 constituting a train-information managing apparatus 114. The driven car 12 includes the electric motor 111, the pantograph 112, the power converting apparatus 110, and a monitor apparatus 125 constituting the train-information managing apparatus 114.

The electric motor 111 performs driving of the front car 11 and the driven car 12 and generates braking force when the electric motor 111 operates as a generator. The pantograph 112 performs transmission and reception of electric power between the wire 5 and the train 1. In the front car 11 and the driven car 12, the power converting apparatuses 110 convert electric power supplied from the wire 5 and supply the electric power to the electric motor 111. The monitor apparatus 115 performs collective management of information concerning components and service equipment mounted on the train 1 (hereinafter, “train information”). Information concerning cars other than the front car 11 is collected by communication between the monitor apparatus 115 and monitor apparatuses 125 mounted on other cars including the driven car 12 via a communication path 8. The train-information transmitting and receiving apparatus 116 transmits the information held by the monitor apparatus 115 to other trains or external apparatuses (systems) via the train antenna 117 and the wide area network 3 that connects the direction center 4 and the substation 2. Communication between the train-information managing apparatus 114 and the external systems is not limited to radio communication, a wide area network, and the like. It goes without saying that the communication can be performed by using various communication means such as satellite communication and wire communication.

The power converting apparatus 110 includes a main circuit 113. A capacitor 118 as a part of an input and output filter circuit is provided at an input end (on the pantograph 112 side) of the main circuit 113. The main circuit 113 observes the voltages at both ends of the capacitor 118 and outputs the observed voltages to the train-information managing apparatus 114 as a wire voltage value. The main circuit 113 observes electric current flowing between the wire 5 and the main circuit 113 via the pantograph 112 and outputs the electric current to the train-information managing apparatus 114 as a main circuit current value.

When the train 1 is performing power running, electric current is consumed by the electric motor 111 and main circuit current is electric current supplied from the pantograph 112 side to the main circuit 113. A main circuit current value at this point is defined as a “+ (plus)” current value. On the other hand, when the electric motor 111 operates as a generator, because the electric motor 111 itself generates electric power, the main circuit current is electric current supplied from the main circuit 113 to the pantograph 112 side. A main circuit current value at this point is defined as a “− (minus)” current value. An observation method of the wire voltage value and the main circuit current value can be any method. It is possible to use, for example, a PT (Potential Transformer) or a CT (Current Transformer).

The train-information managing apparatus 114 calculates electric power amount for each of the cars from wire voltage values and main circuit current values observed by the main circuits 113 of the front car 11 and the driven cars 12 and adds up electric power amounts of all the cars coupled to the train 1 to calculate the electric power amount of the entire train. If the calculated electric power amount is “+ (plus)”, the train 1 is consuming electric power. If the calculated electric power amount is “− (minus)”, the train 1 is regenerating electric power. In the following explanation, the electric power amount calculated by the train-information managing apparatus 114 is represented as consumed/regenerated electric power amount.

The monitor apparatus 115 of the front car 11 included in the train-information managing apparatus 114 has mileage information as service information of the train 1. The monitor apparatus 115 specifies, based on this mileage information, a present location where the train 1 is traveling. A method of specifying the present location of the train 1 can be, for example, a method by a GPS (Global Positioning System).

The train-information managing apparatus 114 outputs information concerning the calculated consumed/regenerated electric power amount (hereinafter, “consumed/regenerated electric power amount information”) and present train location information indicating the location where the train 1 is traveling to the wide area network 3.

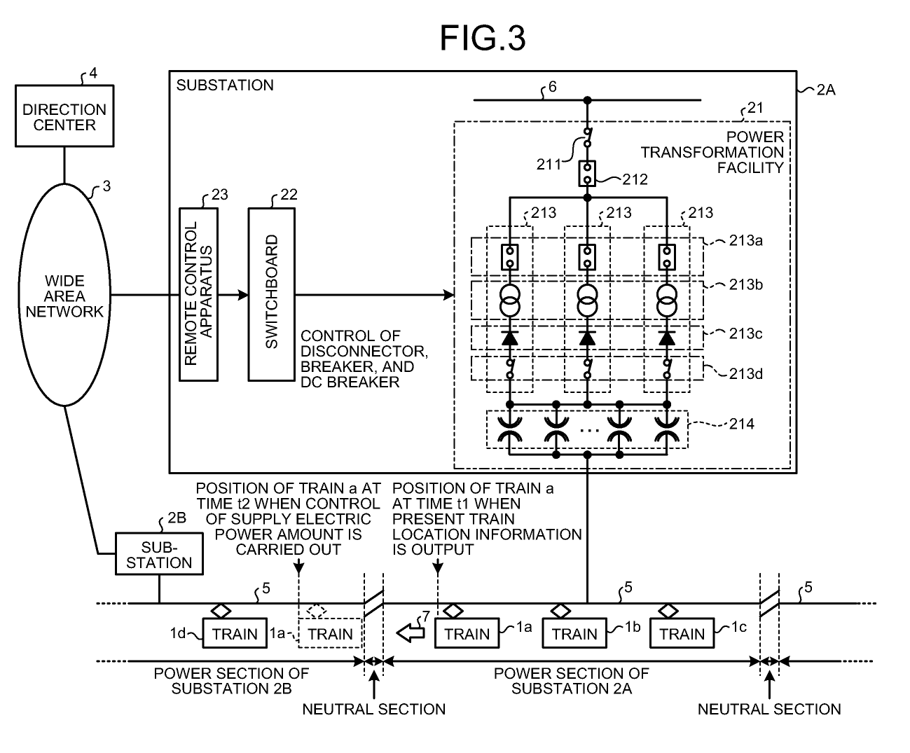

The configuration and the operation on a substation side of the power supply control system according to the first embodiment are explained. FIG. 3 is a diagram of a configuration example mainly on the substation side and an example of connection of the power supply control system to the wired network according to the first embodiment.

The direction center 4 outputs a power supply schedule to substations 2 (2A and 2B) via the wide area network 3. The power supply schedule is predicted and created in advance based on a service schedule of trains.

The configuration of the substations 2 is explained using the substation 2A shown in more detail. The substation 2A includes a power transformation facility 21, a switchboard 22, and a remote control apparatus 23. The power transformation facility 21 generates electric power supplied from a bus 6 as a supply source of electric power to the wire 5. The remote control apparatus 23 performs control of the power transformation facility 21 via the switchboard 22.

A power supply path of the power transformation facility 21 branches from the bus 6 to a plurality of systems 213 via a disconnector 211 and a breaker 212. The systems 213 include breakers 213a, transformers 213b, rectifiers 213c, and disconnectors 213d. Outputs of the systems 213 are, after being merged into one again, connected to the wire 5 via a plurality of DC breakers 214 connected in parallel.

The remote control apparatus 23 performs, in addition to static control based on the power supply schedule input from the direction center 4 via the wide area network 3, dynamic control explained below based on consumed/regenerated electric power amount information output on a real time basis from the train 1 traveling in a power section to which the substation 2, in which the remote control apparatus 23 is set, supplies electric power. Timing for switching between the static control and the dynamic control is enough if the switching is performed so appropriately that power supply is performed most efficiently (e.g., the dynamic control is performed only in the daytime with a small number of traveling trains when regenerated power is not fully consumed).

Usually, as explained above, switching of electric power amount supplied by the substation 2 is performed based on the power supply schedule predicted in advance based on the service information of trains. On the other hand, in this embodiment, the switching is performed based on the consumed/regenerated electric power amount information from the train 1 according to startup/shutdown of the respective breakers 213a and startup/shutdown of the respective DC breakers 214 in the systems of the power transformation facility 21. This control makes it possible to perform finer switching control of supplied electric power amount.

Control of supplied electric power amount based on present train location information and consumed/regenerated electric power amount information transmitted from the trains is explained.

The remote control apparatus 23 extracts, out of consumed/regenerated electric power amount information input via the wide area network 3, based on present train location information attached to the consumed/regenerated electric power amount information, consumed/regenerated electric power amount information concerning trains traveling in a power section as a control target and calculates a total value of the extracted consumed/regenerated electric power amount information. In the example shown in FIG. 3, the remote control apparatus 23 of the substation 2A calculates a total of consumed/regenerated electric power amounts of trains 1a, 1b, and 1c extracted based on the present train location information out of consumed/regenerated electric power amount information concerning trains 1a to 1d.

When a total of consumed/regenerated electric power amounts of trains traveling in the power section of the substation 2 is “− (minus)”, the remote control apparatus 23 performs control for shutting down some of the DC breakers 214 in the power transformation facility 21 according to the total of the consumed/regenerated electric power amounts and reducing electric power amount supplied by substation 2. When the total of the consumed/regenerated electric power amounts of the trains traveling in the power section of the substation 2 is “+ (plus)”, the remote control apparatus 23 performs control for starting up some of the DC breakers 214 in the power transformation facility 21 according to the total of the consumed/regenerated electric power amounts and increasing the electric power amount supplied by the substation 2. It goes without saying that, in the control of the supplied electric power amount, when the total of the regenerated electric power amounts substantially exceeds a total of consumed electric power amounts, the remote control apparatus 23 can perform control for reducing the supplied electric power amount by shutting down the respective breakers 213a provided in the systems 213.

According to the first embodiment, a plurality of trains present in a power section to which electric power is supplied are specified and electric power amount supplied by the substation is controlled based on the total of consumed electric power amounts of a plurality of trains that are performing power running and regenerated electric power amount of a plurality of trains that are performing regeneration. Therefore, it is possible to supply regenerated electric power of a train that is performing regeneration in a power section of the substation to a train that is performing power running in the same power section and effectively use electric power generated by the train. When the total of the regenerated electric power amounts of the trains that are performing regeneration exceeds the total of the consumed electric power amounts of the trains that are performing power running, it is possible to reduce the electric power amount supplied by the substation.

### Second Embodiment

In the first embodiment, the remote control apparatus 23 performs the control of electric power amount based on the consumed/regenerated electric power amount information transmitted from the train side. On the other hand, because the trains are traveling, a certain degree of a time difference (a time lag) occurs after the train-information managing apparatus 114 outputs present train location information until the remote control apparatus 23 carries out control of electric power amount supplied by the substation 2. This situation is shown in FIG. 3. As shown in FIG. 3, a situation in which the train 1a travels in a traveling direction 7 indicated by an arrow in the figure and moves to a power section of the substation 2B beyond a neutral section occurs after the train 1a traveling in a power section of the substation 2A outputs present train location information at time t1 until the remote control apparatus 23 of the substation 2A applies control of supplied electric power amount to the power section of the substation 2A at t2. In this case, as a desirable control manner, consumed/regenerated electric power amount information transmitted from the train 1a is used when the remote control apparatus 23 of the substation 2B applies control of supplied electric power amount to the power section of the substation 2B. In the second embodiment, this control is realized.

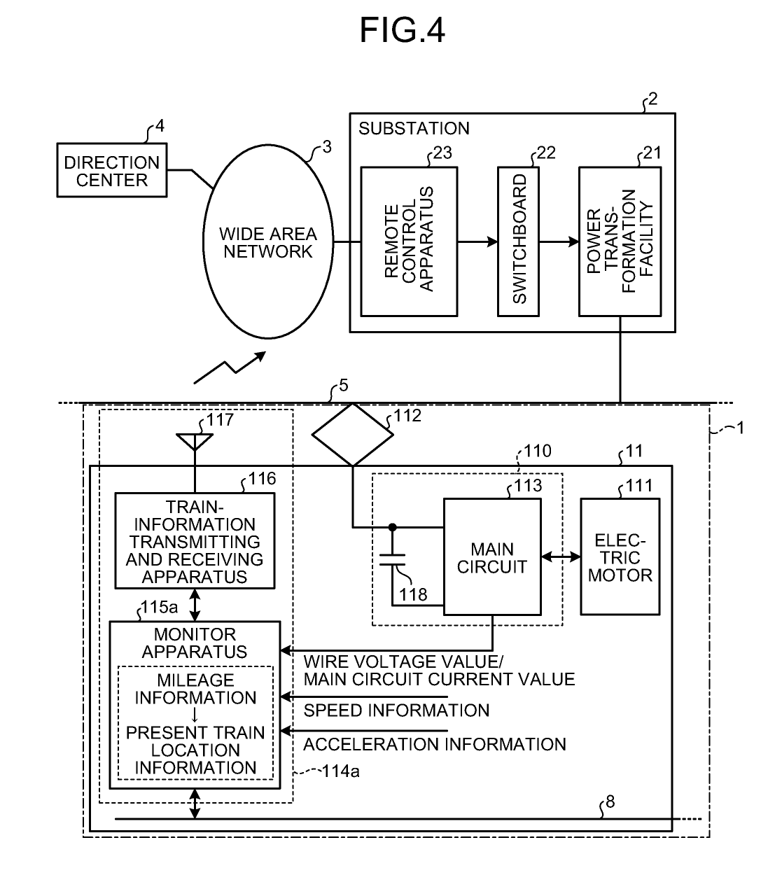

FIG. 4 is a diagram of a configuration example mainly on the train 1 side of a power supply control system according to the second embodiment. Components same as or equivalent to those in the first embodiment are denoted by the same reference numerals and signs and detailed explanation of the components is omitted.

In the second embodiment, in addition to the wire voltage value and the main circuit current value, speed information and acceleration information of the train 1 in train information held by a train-information managing apparatus 114a are used. The train-information managing apparatus 114a outputs the speed information and the acceleration information of the train 1 to the wide area network 3 in addition to the consumed/regenerated electric power amount information and the present train location information of the train 1.

The remote control apparatus 23 predicts, based on present train location information, speed information, and acceleration information output by trains, the position of the train 1 at time (an hour) when control of supplied electric power amount is carried out and calculates, based on the prediction, a total of electric power amounts of trains present in a power section at time when the control of the supplied electric power amount is carried out. The remote control apparatus 23 performs control of electric power amount supplied by the substation 2 based on a result of the calculation. The position of the train 1 can be predicted based on the present train location information and the speed information. However, the position prediction can be more accurately performed by taking into account the acceleration information.

According to the second embodiment, a train scheduled to be present in a power section in which the substation supplies electric power is predicted at time when control of supplied electric power amount by the remote control apparatus is carried out. Electric power amount supplied by the substation is controlled based on the of consumed electric power amounts of a plurality of trains scheduled to be present that are performing power running and regenerated electric power amounts of a plurality of trains scheduled to be present in the power section that are performing regeneration. Therefore, it is possible to more accurately control electric power amount supplied by the substation and more effectively use electric power generated by a train than in the first embodiment.

The speed information and the acceleration information can be calculated by any method. For example, the acceleration information can be calculated according to, for example, speed information of a tachometer generator and the present train location information.

Operation command (power running and braking) information input from a master controller of a driver's cab is further output from the train-information managing apparatus 114a to the remote control apparatus 23 and the position of the train 1 is predicted by taking into account a traveling state (an acceleration state or a deceleration state) of the train 1. This makes it possible to more accurately control electric power amount supplied by the substation.

### INDUSTRIAL APPLICABILITY

As explained above, the power supply control system according to the present invention is useful as an invention that can effectively use regenerated power of a train and reduce power supplied by a substation in a power supply control system in an electric railroad.

1. A power supply control system that controls supplied power to a train using a remote control apparatus provided on a substation side and a train-information managing apparatus provided in the train, which collectively manages train information to the remote control apparatus via a wide area network, wherein
the train-information managing apparatus outputs present train location information indicating a location where the train is traveling and consumed/regenerated electric power amount information indicating consumed electric power amount and regenerated electric power amount of the train, which are calculated from a wire voltage value and a main circuit current value observed in a main circuit of a power converting apparatus provided in the train, to the remote control apparatus, and
the remote control apparatus extracts, out of the input consumed/regenerated electric power amount information, based on the present train location information attached to the consumed/regenerated electric power amount information, consumed/regenerated electric power amount information concerning a train traveling in a power section as a control target, calculates a total value of the extracted consumed/regenerated electric power amount information, and controls, based on the calculated total value of the consumed/regenerated electric power amount information, electric power amount supplied to the power section as the control target.

2. A power supply control system that controls supplied power to a train using a remote control apparatus provided on a substation side and a train-information managing apparatus provided in the train, which collectively manages train information and transmits collected train information to the remote control apparatus via a wide area network, wherein
the train-information managing apparatus outputs present train location information indicating a location where the train is traveling, train speed information and train acceleration information, and consumed/regenerated electric power amount information indicating consumed electric power amount and regenerated electric power amount of the train, which are calculated from a wire voltage value and a main circuit current value observed in a main circuit of a power converting apparatus provided in the train, to the remote control apparatus, and
the remote control apparatus predicts, out of the input consumed/regenerated electric power amount information, based on the present train location information, the train speed information, and the train acceleration information attached to the consumed/regenerated electric power amount information, a train scheduled to be present in a power section as a control target at time when control of supplied electric power amount is carried out, extracts consumed/regenerated electric power amount information concerning the predicted train scheduled to be present and calculates a total value of the consumed/regenerated electric power amount information, and controls, based on the calculated total value of the consumed/regenerated electric power amount information, electric power amount supplied to the power section as the control target.

3. The power supply control system according to claim 1, wherein the remote control apparatus performs, when the total value of the consumed/regenerated electric power amount information is plus and the train consumes electric power, control for increasing the electric power amount supplied to the power section and performs, when the total value of the consumed/regenerated electric power amount information is minus and the train regenerates electric power, control for reducing the electric power amount supplied to the power section.

4. A power supply control method for controlling supplied power to a train using a remote control apparatus provided on a substation side and a train-information managing apparatus provided in a train, which collectively manages train information and transmits collected train information to the remote control apparatus via a wide area network, wherein
the remote control apparatus performs control of electric power amount supplied to a power section as a control target of the substation while switching,
static control for controlling, based on a power supply schedule created based on a service schedule of a train, electric power amount supplied by the substation; and
dynamic control for controlling, based on consumed/regenerated electric power amount information indicating consumed electric power amount and regenerated electric power amount of the train, which are calculated from a wire voltage value and a main circuit current value observed in a main circuit of a power converting apparatus provided in the train traveling in the power station as the control target of the substation, the electric power amount supplied by the substation.

5. The power supply control method according to claim 4, wherein, as the dynamic control,
the train-information managing apparatus includes a step of transmitting present train location information indicating a location where the train is traveling and the consumed/regenerated electric power amount information to the remote control apparatus, and
the remote control apparatus includes:
a receiving step of receiving the consumed/regenerated electric power amount information from the train-information managing apparatus and the present train location information attached to the consumed/regenerated electric power amount information;
an extracting step of extracting, based on the present train location information, consumed/regenerated electric power amount information concerning a train traveling in a power section as a control target;
a calculating step of calculating a total value of the extracted consumed/regenerated electric power amount information; and
a control step of controlling, based on the calculated total value of the consumed/regenerated electric power amount information, electric power amount supplied to the power section as the control target.

6. The power supply control method according to claim 4, wherein, as the dynamic control,
the train-information managing apparatus includes a step of transmitting present train location information indicating a location where the train is traveling, train speed information and train acceleration information, and the consumed/regenerated electric power amount information to the remote control apparatus, and
the remote control apparatus includes:
a receiving step of receiving the consumed/regenerated electric power amount information from the train-information managing apparatus and the present train location information, the train speed information, and the train acceleration information attached to the consumed/regenerated electric power amount information;
a predicting step of predicting, based on the present train location information, the train speed information, and the train acceleration information, a train scheduled to be present in a power section as a control target at time when control of supplied electric power amount is carried out;
a calculating step of extracting consumed/regenerated electric power amount information concerning the predicted train to be present and calculating a total value of the consumed/regenerated electric power amount information; and
a control step of controlling, based on the calculated total value of the consumed/regenerated electric power amount information, electric power amount supplied to the power section as the control target.

7. The power supply control system according to claim 1, wherein the remote control apparatus performs control of electric power amount supplied to the power section as the control target of the substation while switching:
static control for controlling, based on a power supply schedule created based on a service schedule of the train, electric power amount supplied by the substation; and
dynamic control for controlling, based on consumed/regenerated electric power amount information indicating consumed electric power amount or regenerated electric power amount of the train traveling in the power section as the control target of the substation, the electric power amount supplied by the substation.

8. The power supply control method according to claim 4, wherein the remote control apparatus performs the dynamic control when there are only a small number of services of the train traveling in the power section as the control target of the substation and the regenerated electric power amount exceeds the consumed electric power amount.

9. The power supply control system according to claim 7, wherein the remote control apparatus performs the dynamic control when there are only a small number of services of the train traveling in the power section as the control target of the substation and the regenerated electric power amount exceeds the consumed electric power amount.

10. The power supply control system according to claim 1, wherein the train-information managing apparatus adds up electric power amounts of all cars coupled to the train to calculate the consumed/regenerated electric power amount information.

11. The power supply control system according to claim 1, wherein the train-information managing apparatus specifies a present location of the train using mileage information indicating a distance from a start point to a reference point in a section in which the train travels or a GPS to obtain the present train location information.

12. The power supply control system according to claim 2, wherein the remote control apparatus performs, when the total value of the consumed/regenerated electric power amount information is plus and the train consumes electric power, control for increasing the electric power amount supplied to the power section and performs, when the total value of the consumed/regenerated electric power amount information is minus and the train regenerates electric power, control for reducing the electric power amount supplied to the power section.

13. The power supply control system according to claim 2, wherein the remote control apparatus performs control of electric power amount supplied to the power section as the control target of the substation while switching:
static control for controlling, based on a power supply schedule created based on a service schedule of a train, electric power amount supplied by the substation; and
dynamic control for controlling, based on consumed/regenerated electric power amount information indicating consumed electric power amount or regenerated electric power amount of the train traveling in the power section as the control target of the substation, the electric power amount supplied by the substation.

14. The power supply control system according to claim 13, wherein the remote control apparatus performs the dynamic control when there are only a small number of services of the train traveling in the power section as the control target of the substation and the regenerated electric power amount exceeds the consumed electric power amount.

15. The power supply control system according to claim 2, wherein the train-information managing apparatus adds up electric power amounts of all cars coupled to the train to calculate the consumed/regenerated electric power amount information.

16. The power supply control system according to claim 2, wherein the train-information managing apparatus specifies a present location of the train using mileage information indicating a distance from a start point to a reference point in a section in which the train travels or a GPS to obtain the present train location information.
